(19) United States
(12) Patent Application Publication
(10) Pub. No.: US 2015/0061804 A1
(43) Pub. Date: Mar. 5, 2015

(54) REACTOR UNIT

(71) Applicants: Koji Katano, Toyota-shi (JP); Hiroyuki Sekine, Nisshin-shi (JP); Ikuhiro Nakamura, Toyota-shi (JP)

(72) Inventors: Koji Katano, Toyota-shi (JP); Hiroyuki Sekine, Nisshin-shi (JP); Ikuhiro Nakamura, Toyota-shi (JP)

(73) Assignee: TOYOTA JIDOSHA KABUSHIKI KAISHA, Toyota-shi (JP)

(21) Appl. No.: 14/385,096

(22) PCT Filed: Mar. 15, 2012
(86) PCT No.: PCT/JP2012/056748

§ 371 Date: Sep. 12, 2014

(51) Int. Cl. H01F 27/06; H01F 27/16

(52) U.S. Cl. CPC H01F 27/06; H01F 27/16
USPC 336/61; 336/65

(57) ABSTRACT

A reactor unit comprises a reactor and a base to which the reactor is attached. The base has base-side bonding surfaces to be bonded to a bonding surface of the reactor. A base connector, which does not include the base-side bonding surfaces, is configured to have a thickness smaller than those of first and second bases, which include the base-side bonding surfaces.

### TECHNICAL FIELD

The present invention relates to a reactor unit.

### BACKGROUND ART

Currently, a reactor made by winding a coil around a magnetic core is used as a component of a DC-DC converter to be installed in hybrid cars, electric cars, fuel cell cars, etc. In recent years, the technique of providing a radiator (fin) for such reactor itself, which has a magnetic core and a coil, and immersing the radiator in a cooling medium has been proposed (see, for example, Patent Document 1).

### PRIOR ART REFERENCE

### Patent Document

Patent Document 1: JP2010-118610 A

### SUMMARY OF THE INVENTION

### Problem to be Solved by the Invention

A conventional reactor, as in the one described in Patent Document 1, is bonded to a cooling base having an interior space filled with a cooling medium (cooling water) and the bonded part thereof is usually sealed with an O-ring or the like. If a torsional force is exerted on the cooling base, however, the bonded surface (sealed surface) with the reactor becomes distorted, which could cause leakage of the cooling medium within the cooling base. The same problem could also occur in the case of fixing the reactor to the cooling base with a bolt.

The present invention has been made in view of the above-described circumstances. An object of the present invention is to maintain, in a reactor unit having a reactor and a base, the bonded state between the reactor and the base even if a torsional force is exerted on the base.

### Means for Solving the Problem

In order to achieve the above object, a reactor unit according to the present invention comprises a reactor and a base to which the reactor is attached, wherein the base has a base-side bonding surface to be bonded to a bonding surface of the reactor, and wherein the base is configured such that a portion not including the base-side bonding surface has a thickness smaller than that of a portion including the base-side bonding surface.

By adopting the above configuration, the base is configured such that a portion not including the base-side bonding surface to be bonded to the bonding surface of the reactor has a thickness smaller than that of a portion including the base-side bonding surface. As a result, if a torsional force is exerted on the base, it is possible to allow such torsion to occur first in the portion not including the base-side bonding surface (thin portion), and an occurrence of torsion in the portion including the base-side bonding surface (thick portion) can thereby be suppressed. Accordingly, the bonded state between the reactor and the base can be maintained even if a torsional force is exerted on the base.

In the reactor unit according to the present invention, the portion not including the base-side bonding surface may have a reinforced region.

By adopting the above configuration, the strength of the portion not including the base-side bonding surface (thin portion) can be ensured.

Further, in the reactor unit according to the present invention, the base may have a fixation screw for fixing the base to a predetermined structure, and the region where the fixation screw is provided may serve as the reinforced region.

By adopting the above configuration, the region including the fixation screw, which is configured to be relatively thick, can be used as a region acting as the reinforced region.

Further, in the reactor unit according to the present invention, it is possible to adopt a base having a first base to which a first reactor is attached and a second base to which a second reactor is attached, wherein the first and second bases are connected in communication with each other via a flow path through which a cooling medium flows, the cooling medium being in contact with a radiator provided in the first and second reactors. In that case, the region where the flow path is provided may serve as the reinforced region.

By adopting the above configuration, the region including the flow path, which is configured to be relatively thick, can be used as a region acting as the reinforced region.

Further, in the reactor unit according to the present invention, it is preferable to provide a rib for the reinforced region and to set the height of the rib so as not to reach the base-side bonding surface

By adopting the above configuration, since the height of the rib provided in the reinforced region is set in advance so as not to reach the base-side bonding surface, the rib does not interfere when bonding the bonding surface of the reactor to the base-side bonding surface of the base. As a result, the step of adjusting the height of the rib (trimming is not needed when attaching the reactor to the base, and this improves workability.

Further, in the reactor unit according to the present invention, the thickness of the portion not including the base-side bonding surface may be made smaller than that of the portion including the base-side bonding surface by cutting out a side surface of the base.

By adopting the above configuration, even in the case where cutting out the surface of the base is difficult due to the positional relationship between the reactor and other structures, a thin portion (portion not including the base-side bonding surface) can be easily formed by cutting out the side surface of the base.

Further, in the reactor unit according to the present invention, the base-side bonding surface may be formed at both ends in the thickness direction of the portion including the base-side bonding surface. In that case, the portion not including the base-side bonding surface is preferably connected and joined to the portion including the base-side bonding surface, approximately at the center in the thickness direction thereof.

By adopting the above configuration, a torsion moment from the portion not including the base-side bonding surface (thin portion) is transferred substantially evenly to the base-side bonding surfaces formed at both ends in the thickness direction of the portion including the base-side bonding surface (thick portion). Accordingly, it is possible to suppress the transfer of a large torsional moment to only one of the base-side bonding surfaces.

The reactor unit according to the present invention may further have a switching device or a capacitor.

### Effect of the Invention

According to the present invention, in a reactor unit having a reactor and a base, the bonded state between the reactor and the base can be maintained even if a torsional force is exerted on the base.

### BRIEF DESCRIPTION OF THE DRAWINGS

FIG. 1 is a plan view of a reactor unit according to an embodiment of the present invention (in a state where a reactor is not attached to a base).

FIG. 2 is a cross-sectional view of the reactor unit shown in FIG. 1 (in a state where the reactor has been attached to the base) along the line II-II.

FIG. 3 is a cross-sectional view of the reactor unit shown in FIG. 1 (in a state where the reactor has been attached to the base) along the line III-III.

### MODE FOR CARRYING OUT THE INVENTION

Hereinafter, a reactor unit 1 according to an embodiment of the present invention will be described, with reference to the drawings.

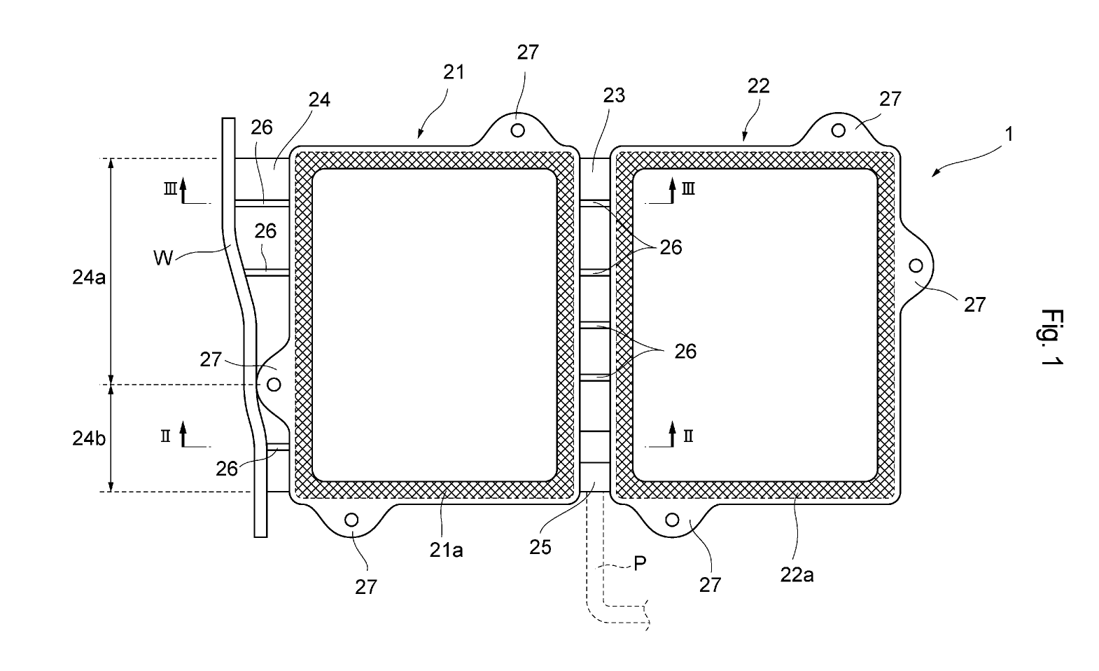

The reactor unit 1 according to this embodiment is used as a component of a DC-DC converter for a fuel cell vehicle. As shown in FIGS. 1 to 3, the reactor unit 1 has a reactor 10 and a base 20 to which the reactor 10 is attached.

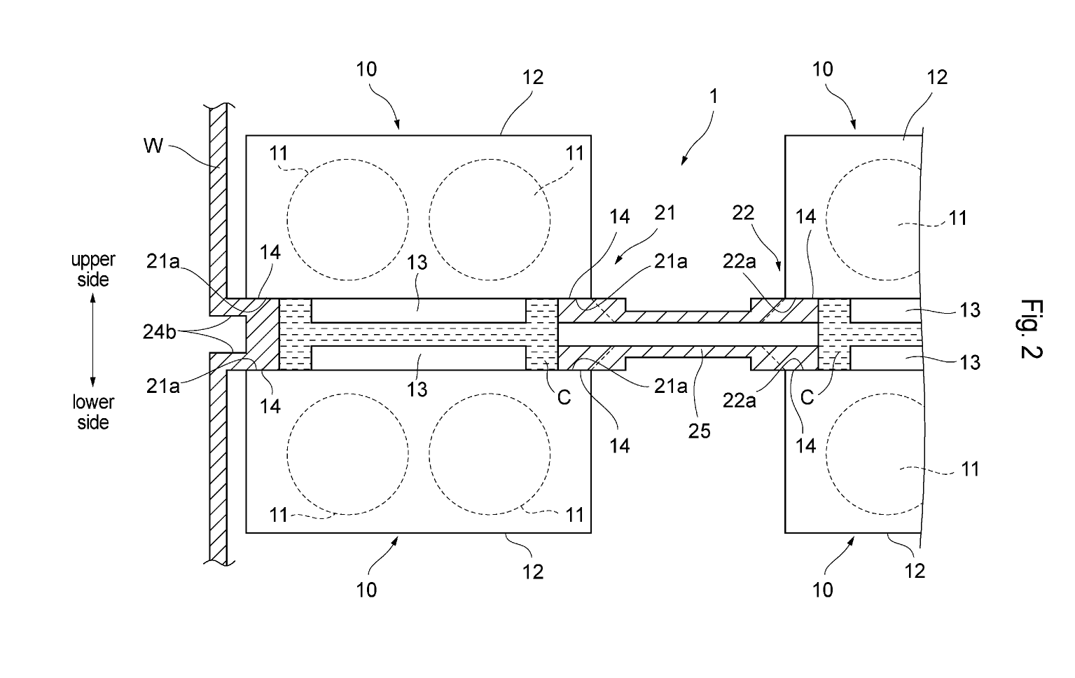

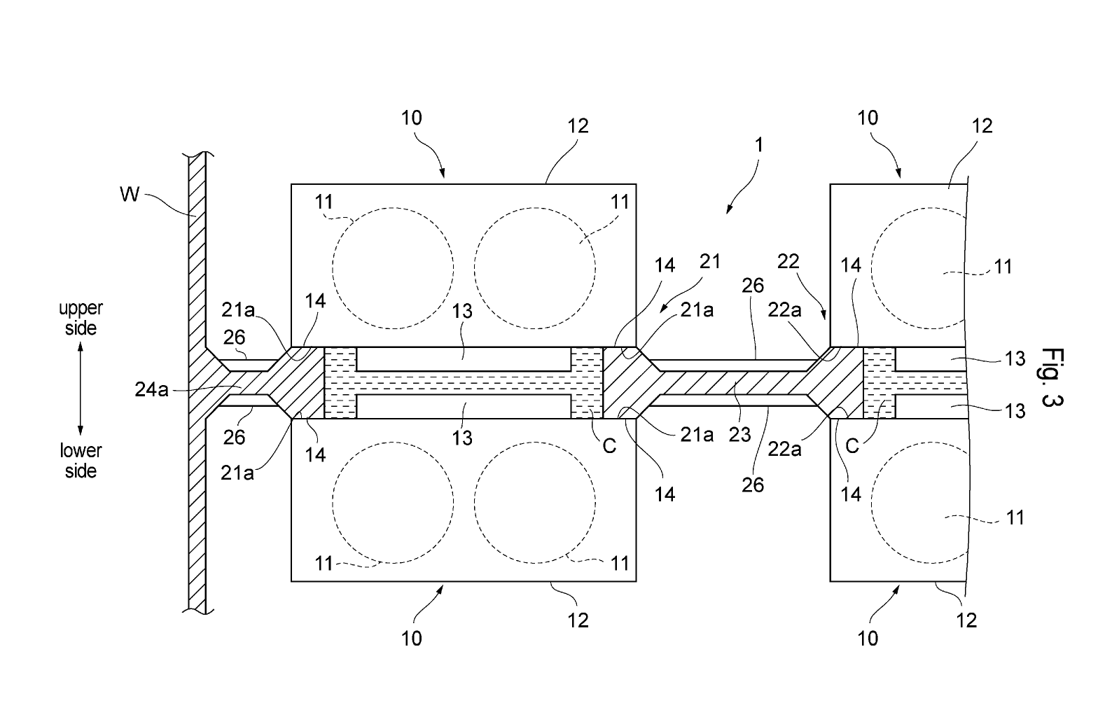

The reactor 10 has: a cylindrical body 11 formed by winding a coil around a magnetic core; and a cover 12 that covers the cylindrical body 11. In this embodiment, as shown in FIGS. 2 and 3, two cylindrical bodies 11 are arranged to be lined up in the lateral direction (horizontal direction) and a synthetic resin (an epoxy resin, urethane resin, PPS resin, PBT resin, ABS resin, etc.) is provided to cover the outside of the two cylindrical bodies 11, thereby forming the cover 12 having an approximately cuboidal shape.

A radiator 13 made of metal is provided on a surface of the cover 12 of the reactor 10, which faces the base 20. The radiator 13 is a portion which is to be immersed in a cooling medium C introduced into the base 20. Heat generated at the magnetic core and coil of the reactor 10 is transferred to the cooling medium C via the radiator 13, and the cooling of the reactor 10 can accordingly be achieved. In this embodiment, the reactors 10 are arranged vertically above and below the base 20 and two pairs of such vertically arranged reactors 10 are arranged to be lined up in the lateral direction (horizontal direction).

As shown in FIGS. 1 and 3, the base 20 includes: a first base 21 to which a first pair of vertically arranged reactors 10 is attached; a second base 22 to which a second pair of vertically arranged reactors 10 is attached; a base connector 23 that connect the first base 21 and the second base 22; and a wall connector 24 that connects the first base 21 and a specific outer wall W.

As shown in FIGS. 1 and 2, the first base 21 and the second base 22 are connected in communication with each other via a flow path 25 through which the cooling medium C, which is in contact with the radiator 13 provided in the reactor 10, flows. The flow path 25 constitutes a part of the base connector 23 and is configured such that the thickness (the size in the vertical direction) thereof is slightly greater than that of the base connector 23. Accordingly, the region where the flow path 25 is provided in the base connector 23 serves as a reinforced region. It should be noted that an external flow path P is connected to the flow path 25 so that the cooling medium C is introduced into the flow path 25 through the external flow path P.

As shown in FIGS. 1 to 3, the first and second bases 21 and 22 which constitute the base 20 have, at both ends in the thickness direction thereof, base-side bonding surfaces 21a and 22a which are to be bonded to bonding surfaces 14 of the reactors 10. As shown in FIG. 3, the base connector 23, which is a portion not including the base-side bonding surfaces 21a and 22a, is configured so as to be thinner than the first and second bases 21 and 22, which are portions including the base-side bonding surfaces 21 a and 22a. Further, as shown in FIG. 3, the base connector 23 is connected and joined to the first and second bases 21 and 22, approximately at the center in the thickness direction thereof.

The first base 21 of the base 20 has a portion spaced apart from the outer wall W and a portion close to the outer wall W, as shown in FIG. 1. In the wall connector 24, as shown in FIG. 3, a portion (spaced portion) 24a connecting the outer wall W with the portion of the first base 21 spaced apart from the outer wall W is configured so as to have a thickness smaller than that of the first base 21 by cutting the surfaces (upper and lower surfaces) of the spaced portion 24a. Further, as shown in FIG. 3, the spaced portion 24a of the wall connector 24 is connected and joined to the first and second bases 21 and 22, approximately at the center in the thickness direction thereof. On the other hand, as shown in FIG. 2, a portion (close portion) 24b of the wall connector 24, which connects the outer wall W with the portion of the first base 21 close to the outer wall W, is configured so as to have a thickness smaller than that of the first base 21 by cutting a side surface thereof.

As shown in FIGS. 1 and 3, a plurality of ribs 26 is provided in the base connector 23 and the wall connector 24 which constitute the base 20. In the base connector 23 and the wall connector 24, which are configured to be thinner than the first and second bases 21 and 22, the regions having such ribs 26 serve as reinforced regions. In this embodiment, the height of the ribs 26 is set so as not to reach the base-side bonding surfaces 21 a and 22a of the first and second bases 21 and 22.

As shown in FIG. 1, the first and second bases 21 and 22 which constitute the base 20 have a plurality of fixation screws 27 for fixing the first and second bases 21 and 22 to a predetermined structure. Such fixation screw 27 is also provided in the wall connector 24. In the wall connector 24, the region where the fixation screw is provided is configured so as to be thicker than other regions, and such region serves as a reinforced region.

In the reactor unit 1 according to the embodiment described above, the base connector 23 and the wall connector 24 (portions not including the base-side bonding surfaces 21a and 22a to be bonded to the bonding surfaces 14 of the reactors 10) of the base 20 are configured so as to have a thickness smaller than that of the first and second bases 21 and 22 (portions including the base-side bonding surfaces 21a and 22a). As a result, if a torsional force is exerted on the base 20, it is possible to allow such torsion to occur first in the thin base connector 23 and wall connector 24, and an occurrence of torsion in the thick first and second bases 21 and 22 can thereby be suppressed. Accordingly, the bonded state between the reactor 10 and the base 20 can be maintained even if a torsional force is exerted on the base 20.

Further, in the reactor unit 1 according to the embodiment described above, the base connector 23 and the wall connector 24 have reinforced regions (flow path 25, ribs 26 and fixation screws 27). As a result, the strength of the thin base connector 23 and wall connector 24 can thereby be ensured. In particular, in this embodiment, the flow path 25, which is configured so as to be relatively thick, and the fixation screw 27, which is also configured so as to be relatively thick, can be used as regions acting as reinforced regions.

Further, in the reactor unit 1 according to the embodiment described above, the height of the ribs 26 provided in the reinforced region is set in advance so as not to reach the base-side bonding surfaces 21a and 22a. As a result, the ribs 26 do not interfere when the bonding surface 14 of the reactor 10 is bonded to the base-side bonding surfaces 21a and 22a of the base 20. Accordingly, the step of adjusting the height of the ribs (trimming) is not needed when attaching the reactor 10 to the base 20, which improves workability.

Further, in the reactor unit 1 according to the embodiment described above, the thickness of the wall connector 24 can be reduced relative to the thickness of the first base 21 by cutting out a side surface of the close portion 24b of the wall connector 24. In other words, even in the case where cutting out the surfaces (upper and lower surfaces) of the wall connector 24 is difficult because the reactor 10 is close to the outer wall W, a thin portion can easily be formed by cutting out the side surface of the close portion 24b of the wall connector 24.

Further, in the reactor unit 1 according to the embodiment described above, the base bonding surfaces 21a and 22a are formed at both ends in the thickness direction of the first and second bases 21 and 22, and the base connector 23 and the wall connector 24 are connected and joined to the first and second bases 21 and 22, approximately at the center in the thickness direction thereof. As a result, a torsional moment from the base connector 23 or from the wall connector 24 is transferred substantially evenly to the base-side bonding surfaces 21a and 22a formed at both ends in the thickness direction of the first and second bases 21 and 22. Accordingly, it is possible to suppress the transfer of a large torsional moment to either of the base-side bonding surfaces.

Although the above-described embodiment describes an example in which the reactors 10 are arranged above and below the base 20, the reactor 10 may be arranged only above (or below) the base 20. Further, although this embodiment describes an example in which two pairs of vertically arranged reactors 10 are arranged to be lined up in the lateral (horizontal) direction, three or more pairs of reactors 10 may be arranged to be lined up in the lateral direction. Furthermore, the reactor unit 1 may have a switching device and a capacitor.

Although the above-described embodiment describes an example in which the reactor unit according to the present invention is installed in a fuel cell vehicle, the reactor unit according to the present invention may be installed in various types of moving objects other than fuel cell vehicles (hybrid cars, electric cars, robots, ships, airplanes, etc.).

The present invention is not limited to the above-described embodiment. Design modifications to the above embodiment, which will be made by a person skilled in the art as appropriate, are also included in the scope of the present invention, as long as they have the features of the present invention. In other words, each element in the above embodiment and the arrangement, materials, conditions, shapes, dimensions, etc., thereof are not limited to those described above and may be modified as appropriate. In addition, each element in the embodiment may be combined, as long as such combination is technically possible, and such combination is also included in the scope of the present invention as long as it has the features of the present invention.

### DESCRIPTION OF REFERENCE NUMERALS

1 . . . reactor unit; 10 . . . reactor; 14 . . . bonding surface (of reactor); 20 . . . base; 21 . . . first base (portion including base-side bonding surface); 22 . . . second base (portion including base-side bonding surface); 21a, 22a . . . base-side bonding surface; 23 . . . base connector (portion not including base-side bonding surface); 24 . . . wall connector (portion not including base-side bonding surface); 25 . . . flow path; 26 . . . rib; and 27 . . . fixation screw

1. A reactor unit comprising:
a reactor; and
a base to which the reactor is attached,
wherein the base has a base-side bonding surface to be bonded to a bonding surface of the reactor, and wherein the base is configured such that a portion not including the base-side bonding surface has a thickness smaller than that of a portion including the base-side bonding surface.

2. The reactor unit according to claim 1, wherein the portion not including the base-side bonding surface has a reinforced region.

3. The reactor unit according to claim 2,
wherein the base has a fixation screw for fixing the base to a predetermined structure, and
wherein the reinforced region is a region where the fixation screw is provided.

4. The reactor unit according to claim 2,
wherein the base has a first base to which a first reactor is attached and a second base to which a second reactor is attached, and wherein the first and second bases are connected in communication with each other via a flow path through which a cooling medium flows, the cooling medium being in contact with a radiator provided in the first and second reactors, and
wherein the reinforced region is a region where the flow path is provided.

5. The reactor unit according to claim 2,
wherein the reinforced region has a rib, and
wherein a height of the rib is set so as not to reach the base-side bonding surface.

6. The reactor unit according to claim 1, wherein the portion not including the base-side bonding surface is configured to have a thickness smaller than that of the portion including the base-side bonding surface by cutting out a side surface of the base.

7. The reactor unit according to claim 1,
wherein the portion including the base-side bonding surface has the base-side bonding surface at both ends in the thickness direction thereof, and
wherein the portion not including the base-side bonding surface is connected and joined to the portion including the base-side bonding surface, approximately at the center in the thickness direction thereof.

8. The reactor unit according to claim 1, further comprising a switching device.

9. The reactor unit according to claim 1, further comprising a capacitor.
